(19) United States
(12) Patent Application Publication
(10) Pub. No.: US 2026/0225944 A1
(43) Pub. Date: Aug. 6, 2026

(54) GLASS-CERAMIC SEALING MATERIAL

(71) Applicant: Nihon Yamamura Glass Co., Ltd., Amagasaki-shi, Hyogo (JP)

(72) Inventors: Kozo Maeda, Amagasaki-shi, Hyogo (JP); Takuya Takayama, Amagasaki-shi, Hyogo (JP)

(21) Appl. No.: 19/151,262

(22) PCT Filed: Jan. 25, 2024
(86) PCT No.: PCT/JP2024/002307

§ 371 Date: Jul. 25, 2025

(30) Foreign Application Priority Data
Jan. 27, 2023 (JP) 2023-011038

(51) Int. Cl. C03C 8/04; C03C 3/064; C03C 3/066; C03C 3/068; C03C 8/02; C03C 8/14

(52) U.S. Cl. CPC C03C 8/04; C03C 3/064; C03C 3/066; C03C 3/068; C03C 8/02; C03C 8/14

(57) ABSTRACT

A crystallized glass composition not containing alkali metal oxides can be used at a temperature of 750° C. or lower by being fired at 650 to 750° C. The composition is a sealing glass composition substantially not containing alkali metal oxides, and containing, in mol %, SiO2: 8 to 20%, B2O3: 16 to 35%, BaO: 23 to 43%, ZnO: 0 to 26%, and CaO+SrO: 0 to 36%. The glass composition, when fired at a temperature of 700° C. in a form of a powder, forms a crystallized glass that exhibits a thermal expansion coefficient of 110 to 150×10⁻⁷/° C. at 50 to 700° C.

### TECHNICAL FIELD

The present invention relates to a glass composition suitable for sealing or bonding between metals, ceramics, a metal and a ceramic, or the like, and more specifically relates to a sealing glass composition used as, for example, a sealant or the like for bonding between a cell of a fuel cell requiring sealing at 750° C. or lower and a metal to which it is fixed or a sealing position between metals, an exhaust gas sensor, a temperature sensor, or the like.

### BACKGROUND ART

As characteristics required for a sealant for a solid oxide fuel cell (SOFC), the sealant is exposed to a high temperature for a long period of time, and therefore it is required that deterioration and melting do not occur even when the sealant is exposed to a high temperature for a long period of time, and therefore crystallized glass has been proposed. In addition, for sealing between a metal and a ceramic, flowability of glass in a firing process and matching of a thermal expansion coefficient with a member to be bonded are also required.

On the other hand, in the case of conventional crystallized glass for solid oxide fuel cells (SOFC), the glass is required to be fired at a temperature exceeding 700° C., for example, 800° C., according to the operation temperature of the SOFC of 700° C. to 900° C. It is one of the causes of hindrance of spread, and lowering of the operation temperature is required. (Patent Document 1)

However, from the viewpoint of flowability and crystallization, the crystallized glasses for sealing SOFC that has been developed so far are compositions that change from glasses to crystallized glasses by being fired at 800° C. or higher, and have insufficient flowability or insufficient crystallization at a lower temperature, for example, a firing temperature of 700° C., so that the sealing performance after firing tends to deteriorate (Patent Documents 2, 3, and 4).

In order to solve the insufficient flowability, it is common to lower the softening temperature of glass, and in order to lower the softening temperature, it is common to add an alkali metal oxide. However, since there is a possibility that a crystal phase containing an alkali metal oxide melts and contamination of an electrode due to volatilization of the alkali metal oxide is a problem, a sealant not containing alkali metal oxides is desired. A sealant not containing alkali metal oxides has also been developed (Patent Document 1). However, since this sealant contains MgO, a glass phase remains even after firing. Thus, when the sealant is exposed to a high temperature for a long period of time, deterioration may occur.

### PRIOR ART DOCUMENTS

### Patent Document

Patent Document 1: JP-A-2020-164377
Patent Document 2: JP-B2-5906888
Patent Document 3: JP-B2-6621425
Patent Document 4: JP-A-2010-184826

### SUMMARY OF THE INVENTION

### Problems to be Solved by the Invention

In the background described above, an object of the present invention is to provide a crystallized glass composition not containing alkali metal oxides, that can be used at a temperature of 750° C. or lower by being fired at 650 to 750° C.

### Means for Solving the Problems

As a result of repeated studies to solve the above problems, the present inventors have found that SiO₂—B₂O₃—BaO-based glass compositions in a certain component range can form a high-strength crystallized glass (glass ceramic) having 110 to 150×10⁻⁷ (50 to 700° C.), which is a thermal expansion coefficient suitable for metals and the like, and having a high linearity of a thermal expansion curve, when a glass powder consisting of the glass composition is fired at 650 to 750° C., flows and then crystallizes, and these glass compositions can have improved weather resistance by containing WO₃ or Nb₂O₅ or both in a predetermined ratio. Based on these findings, further studies have been conducted to complete the present invention.

That is, the present invention provides the following sealing glass composition.
1. A sealing glass composition substantially not containing alkali metal oxides, and containing, in mol %,
8 to 20% of SiO₂,
16 to 35% of B₂O₃,
23 to 43% of BaO,
0 to 26% of Zno, and
0 to 36% of CaO+SrO,
wherein the glass composition, when fired at a temperature of 700° C. in a form of a powder, forms a crystallized glass that exhibits a thermal expansion coefficient of 110 to 150×10⁻⁷/° C. at 50 to 700° C.
2. The sealing glass composition according to 1 above, substantially not containing alkali metal oxides, and containing, in mol %,
10 to 20% of SiO₂,
20 to 28% of B₂O₃,
30 to 40% of BaO,
8 to 15% of Zno, and
5 to 15% of CaO+SrO,
wherein the glass composition, when fired at a temperature of 700° C. in a form of a powder, forms a crystallized glass that exhibits a thermal expansion coefficient of 110 to 150×10⁻⁷/° C. at 50 to 700° C.
3. The sealing glass composition according to claim 1, containing one or more selected from the group consisting of La₂O₃, Y₂O₃, Yb₂O₃ and CeO₂ at 5 mol % or less in total.
4. The sealing glass composition according to any one of 1 to 3 above, containing one or two selected from the group consisting of TiO₂ and ZrO₂ at 5 mol % or less in total.
5. The sealing glass composition according to any one of 1 to 4 above, containing one or two selected from the group consisting of WO₃ and Nb₂O₅ at 4 mol % or less in total.
6. The sealing glass composition according to any one of 1 to 5 above, which is in a form of a powder.
7. The sealing glass composition according to 6 above, wherein the powder has a mean particle size of 5 to 15 μm.
8. The sealing glass composition according to 6 or 7 above, containing a ceramic filler.
9. A sealing glass composition composed of a pressed powder compact obtained by pressing the powder according to any one of 6 to 8 above.
10. The sealing glass composition according to any one of 6 to 8 above, which contains a solvent and an organic binder and is in a paste-like or sheet-like form.

### Effect of the Invention

According to the present invention having each of the above-described configurations, it is possible to provide a glass composition which has sufficient flowability until crystallization when fired in the form of a powder, and forms a high-strength crystallized glass by cooling, in a form substantially not containing alkali metal oxides. In addition, such crystallized glass having enhanced weather resistance can also be provided. Therefore, it can be used as a sealing material in a portion where it is necessary to seal a metal member and a ceramic member, metal members, and ceramic members used at a high temperature (for example, a sealing position of a solid oxide fuel cell or an exhaust gas sensor). The crystallized glass using the glass composition of the present invention has no possibility of impairing the insulation even when exposed to a high temperature condition of 650 to 750° C. for a long period of time, and has no possibility of reducing the viscosity at such a high temperature. Therefore, when the crystallized glass is used as a sealing material for a sealing position, the durability of the insulation and sealing properties of the sealing position can be enhanced.

### MODE FOR CARRYING OUT THE INVENTION

The reason for limiting each component in the sealing glass of the present invention will be described below.

SiO₂ is an oxide that forms a network of the glass of the present invention, and is preferably contained in a range of 8 to 20 mol %. When the content of SiO₂ is less than 8 mol %, there is a possibility that glass cannot be obtained, and even if glass is obtained, there is a possibility that the formability of glass (the property of being in the form of glass) is insufficient. In addition, when the content exceeds 20 mol %, there is a possibility that the crystallization temperature becomes too high or crystallization does not occur, and therefore sealing performance may become unstable, which is not preferable. The content of SiO₂ is more preferably 10 to 20 mol % in consideration of factors such as moldability and softening temperature of glass.

B₂O₃ is an oxide that forms a network of the glass of the present invention, and is preferably contained in a range of 16 to 35 mol %. When the content of B₂O₃ is less than 16 mol %, there is a possibility that glass cannot be obtained, and even if glass is obtained, there is a possibility that the formability of glass is insufficient. In addition, when the content of B₂O₃ exceeds 35 mol %, there is a possibility that the crystallization temperature becomes too high or crystallization does not occur, and therefore sealing performance may become unstable, which is not preferable. The content of B₂O₃ is more preferably 20 to 28 mol % in consideration of factors such as the formability and softening temperature of glass.

BaO is a component that lowers the melting temperature of the glass of the present invention and lowers the viscosity of the glass by being added, is also a component that crystallizes the glass, and is preferably contained in a range of 23 to 43 mol %. When the content of BaO is less than 23 mol %, there is a possibility that the glass is not crystallized even after firing, and the temperature required for preparing the glass becomes too high. Also, when the content of BaO exceeds 43 mol %, glass cannot be obtained or the temperature at which the glass is crystallized is lowered, which is not preferable. Therefore, the content of BaO is more preferably 30 to 40 mol % in consideration of factors such as the formability and crystallization temperature of glass, and is still more preferably 32 to 38 mol % in consideration of the flowability of glass during firing, the thermal expansion coefficient after crystallization, and the like.

ZnO may not be contained, but is a component having an effect of lowering the softening point and enhancing the flowability of the glass of the present invention, and is preferably contained in a range of up to 26 mol %. When the content of ZnO exceeds 26 mol %, glass may be obtained, but the expansion coefficient after crystallization may not be sufficiently increased. The content of ZnO is more preferably 8 to 15 mol % in consideration of the flowability during firing, the softening point, and the expansion coefficient after crystallization of the glass of the present invention.

CaO and SrO may not be contained, but are components that lower the melting temperature of the glass of the present invention and lower the viscosity of the glass by being added, are also components that crystallize the glass, and are preferably contained in a range of up to 36 mol % in total. When the content of these exceeds 36 mol %, glass cannot be obtained or the crystallization temperature is lowered, which is not preferable. The total amount of CaO and SrO is more preferably 5 to 15 mol % in consideration of factors such as the formability and crystallization temperature of glass.

La₂O₃, Y₂O₃, Yb₂O₃ and CeO₂ are components that increase the flowability at the time of sealing the glass of the present invention and are components capable of adjusting the crystallization onset temperature, and may contain any one more types. However, when the total content exceeds 5 mol %, the proportion of the remaining glass phase increases when the glass of the present invention is fired in powder form, which is not preferable. Therefore, even when La₂O₃, Y₂O₃, Yb₂O₃ and CeO₂ are contained, the total content thereof is preferably kept at 5 mol % or less, and more preferably kept at 3 mol % or less.

TiO₂ and ZrO₂ are components that promote crystal precipitation of the glass of the present invention at the time of sealing and improve the weather resistance of the glass, and either one or both may be contained. However, when the total content of TiO₂ and ZrO₂ exceeds 5 mol %, there is a possibility that the flowability is insufficient in firing in powder form, or the glass remains undissolved in a glass melt at the time of production. Therefore, the total content of them is preferably 5 mol % or less, and more preferably 2 mol % or less even if they are contained.

Al₂O₃ is a component effective for improving the formability of glass and adjusting the crystallization onset temperature. However, when Al₂O₃ is contained in an amount of 5 mol % or more, the glass is not crystallized, or the crystallization onset temperature becomes too high, so that the formation of crystallized glass is hindered, for example, the proportion of the remaining glass phase increases. Therefore, Al₂O₃ should not be contained, and even when Al₂O₃ is contained, the content is preferably less than 5 mol %.

When WO₃ and Nb₂O₅ or one of them is contained in the glass in a predetermined ratio, the weather resistance of the glass can be improved. The total content of WO₃ and Nb₂O₅ is preferably 5 mol % or less, and more preferably 4 mol % or less. At this time, the content of WO₃ is preferably 3 mol % or less, and more preferably 2 mol % or less, and the content of Nb₂O₅ is preferably 3 mol % or less, and more preferably 2 mol % or less.

Incidentally, MgO is exemplified as a component effective for adjusting the crystallization onset temperature. However, when MgO is contained in an amount of 3 mol % or more, the glass is not crystallized or the crystallization onset temperature becomes too high, and the formation of crystallized glass is inhibited such that the proportion of the remaining glass phase increases. Therefore, MgO should not be contained, and even when MgO is contained, the content is preferably less than 3 mol %.

In addition to the above components, Fe₂O₃, CuO, CoO, and NiO can be added in an amount of 2 mol % or less in total for the purpose of improving stability during glass production, suppressing a reaction with a metal during firing, improving adhesion with a metal, and adjusting the type and ratio of precipitated crystals.

While the above-described various components can be contained in the sealing glass composition of the present invention, the alkali metal oxide is a component that easily stabilizes the glass state in the step of preparing glass, but may volatilize and react with a metal while being held at a high temperature. It is thus preferred that the sealing glass composition of the present invention substantially does not contain alkali metal oxides.

Here, the phrase “substantially does not contain” is not intended to prohibit any of contaminant level inclusion, but to allow such inclusion that is merely at a level of contaminants in the raw materials employed for preparing glass. More specifically, with regard to alkali metal oxides, the present invention is deemed “substantially not containing” them if their total content is 3,000 ppm or less in terms of oxides, for such a content will cause no substantial problem in the sealing glass composition of the present invention.

As it is required that the glass powder consisting of the glass composition of the present invention once shrinks during firing and softens and flows to wet metal or ceramic surfaces, the glass powder must exhibit high flowability during firing. For this purpose, it is preferred that the particle size is adjusted by grinding conditions, the 50% particle size (D₅₀) is 5 to 15 μm, and the maximum particle size is 150 μm or less.

Here, in the case of a fine powder of too small particle size, the start of crystallization is accelerated, the composition's flowability during sealing and firing is reduced, and the flow is inhibited. Therefore, it is necessary to increase the number of times of application and firing of the sealing material, which leads to an increase in production cost, which is not preferable. On the other hand, a coarse powder having a large particle size has a problem that powder particles settle and separate when the powder is made into a paste, or when it is applied and dried, and a problem that crystallization tends to be uneven or insufficient and strength decreases. The particle size can be adjusted by removing the above-described fine powder and coarse powder by an operation such as classification. The 50% particle size is preferably 5 μm or more, and more preferably 7 μm or more, and preferably 15 μm or less, and more preferably 10 μm or less. Also, the maximum particle size is 150 μm or less, and more preferably 100 μm or less.

Thus, adjustment may be made to achieve, for example, a mean particle size of 15 μm and a maximum particle size of 150 μm or less; a mean particle size of 10 μm and a maximum particle size of 100 μm or less; a mean particle size of 5 μm and a maximum particle size of 50 μm or less, and the like.

In the present invention, the “mean particle size” refers to a “50% particle size”, which refers to a particle size at which a cumulative particle size from the small particle size side reaches 50% in a volume-based particle size distribution measured using a laser analysis/scattering type particle size distribution meter. An example of such a meter is a laser diffraction/scattering type particle size distribution meter (model name “MT-3000” manufactured by Nikkiso Co., Ltd., manufactured by Nikkiso Co., Ltd.).

The sealing glass composition of the present invention can be used for sealing ceramic and a metal in the form of a glass powder or in the form of a mixture thereof with a ceramic powder. In the sealing, it is possible to perform firing at 650 to 750° C. after application to an object by printing or by a dispenser. In addition, a molded body obtained by mixing the sealing glass composition with the molding aid, then performing dry press molding, and performing pre-firing at a temperature near the softening point of glass can be combined with the paste.

In addition, for the purpose of finely adjusting the thermal expansion coefficient and promoting the crystallization of glass to improve the strength, a ceramic filler can be blended in the glass powder to such an extent that the composition's flowability during firing is not reduced. There is no effect if the blending amount is less than 0.1 wt % relative to the total amount of the powder, while if the blending amount exceeds 15 wt %, the composition's flowability is reduced and its flow during sealing and firing is inhibited, which are not preferable. Therefore, the blending amount is preferably 0.1 to 15 wt %, more preferably 0.5 to 10 wt %, and still more preferably 1 to 5 wt %.

Examples of the ceramic filler include barium titanate, forsterite, steatite, wollastonite, alumina, zirconia, partially stabilized zirconia, and magnesia. The 50% particle size of the ceramic filler is preferably 20 μm or less, more preferably 5 μm or less, and still more preferably 3 μm or less, and the maximum particle size is 106 μm or less, more preferably 45 μm or less, and still more preferably 22 μm or less.

The sealing glass composition of the present invention can be used in the form of a glass powder or in the form of further mixing the glass powder with a ceramic powder, but can also be used, for example, in the form of a paste.

When the sealing glass composition of the present invention is used in the form of a paste, it may be prepared by mixing at least one of a solvent and an organic binder. For example, a paste can be prepared by mixing the glass composition in the form of a powder of the present invention, a solvent, and an organic binder. In the case of preparing a paste, the 50% particle size of the sealing glass composition in the form of a powder is not particularly limited, but is usually preferably 5 to 15 μm, and more preferably 5 to 10 μm.

What is used as the organic binder is not particularly limited, and can be appropriately adopted from known binders according to the specific use of the sealing glass composition. Examples thereof include cellulose resins such as ethyl cellulose, but are not limited thereto.

The solvent may be appropriately selected according to the type of the binder to be used, and examples thereof include, but are not limited to, alcohols such as ethanol, methanol, and IPA, and organic solvents such as terpineol (α-terpineol or a mixture of β-terpineol and γ-terpineol mainly composed of α-terpineol). The solvents may be used singly or in combination of two or more thereof.

In addition, in the preparation of the paste, known additives such as a plasticizer, a thickener, a sensitizer, a surfactant, and a dispersant can be appropriately blended as necessary.

The object can be sealed by applying the sealing glass composition of the present invention to the surface of the object by printing or by a dispenser, and then firing the composition at 650 to 750° C. Further, it is also possible to perform dry press molding using a sealing glass composition in which a molding aid was blended, pre-fire a molded body at a temperature near the softening point of glass, combine the molded body with the paste, apply the mixture to the surface of the object, and fire the object. In this case, as the molding aid for dry press molding, for example, polyethylene glycol can be used, but the molding aid is not limited thereto.

### EXAMPLES

Hereinafter, the present invention will be described in more detail with reference to typical examples. However, it is not intended that the present invention be limited to those examples.

### 1. (Examples 1 to 36, Comparative Examples 1 to 5)

### [Production of Glass and Glass Powder]

As shown in Tables 1 to 7, raw materials were prepared and mixed so as to give the glass compositions of Examples 1 to 36 and Comparative Examples 1 to 5. The prepared raw materials were put in a platinum crucible, melted at 1200 to 1400° C. for 2 hours, and then rapidly cooled by twin rolls to obtain glass flakes. The glass flakes were put in a pot mill, and ground until the 50% particle size reached 5 to 15 μm, and then coarse particles were removed using a sieve with a mesh size of 106 μm to give glass powders of Examples and Comparative Examples.

### [Test Method]

For the glass powders of Examples and Comparative Examples, the softening point, crystallization peak temperature, and mean particle size of the glass powder were measured by the following methods. Also, the glass powders were fired, the thermal expansion coefficient of the pressed powder compact was measured and evaluated, and the glass compositions were further subjected to a weather resistance test. The results are shown in Tables 1 to 7.

### (1) Glass Transition Point (Tg), Softening Point (Ts), Crystallization Peak Temperature (Tp)

A platinum cell was filled with about 40 mg of each glass powder, and a softening point (Ts) and a crystallization peak temperature (Tp) were measured by raising the temperature from room temperature to 1000° C. at 20° C./min using a DTA analyzer (Thermo Plus TG8120 manufactured by Rigaku Holdings Corporation).

### (2) 50% Particle Size (D₅₀) of Glass Powder

The 50% particle size of the glass powder was measured using a laser diffraction/scattering type particle size distribution analyzer (model name “MT-3000” manufactured by Nikkiso Co., Ltd., manufactured by Nikkiso Co., Ltd.).

### (3) Thermal Expansion Coefficient (α)

5 g of each obtained glass powder was placed in a mold with an inner diameter of 20 mm, press-molded at 3 MPa for 10 seconds, heated from room temperature to 700° C. at a rate of 200° C./1 hour, and fired at this temperature. The obtained sintered body was cut into about 5×5×15 mm to prepare a test piece. For each test piece, a thermal expansion coefficient (x) was determined based on two points of 50° C. and 700° C. on a thermal expansion curve obtained when the temperature was raised from room temperature at 10° C./min using a TMA analyzer.

### (4) Weather Resistance

The glass compositions of Examples 1, 2, 6, 10, 12, 15, 23, and 24 were subjected to a weather resistance test. That is, in addition to the preparation of the glass flakes, a part of the glass melt was poured out onto a carbon plate that had been heated in advance to obtain a glass lump, and the glass lump was cut into a plate of 15×10×3 mm, dried at 100° C. for 30 minutes, and then weighed. This was immersed in ion-exchanged water at 45° C. for 2 hours, then dried at 100° C. for 30 minutes, and weighed, and the weight reduction rate (%) was calculated and used as an index of weather resistance.

### 2. Examples 37 and 38

Also, in Examples 37 and 38, the glass powder of Example 2 and a filler (barium titanate), and the glass powder of Example 7 and a filler (steatite) were mixed at the mixing ratio shown in Table 8. Also for these mixed powders, a test piece was each prepared in the same manner, and the thermal expansion coefficient (x) was determined.

### [Table 1]

TABLE 1

| mol % | Example 1 | Example 2 | Example 3 | Example 4 | Example 5 | Example 6 |
|---|---|---|---|---|---|---|
| SiO₂ | 10.0 | 12.0 | 12.0 | 12.0 | 12.0 | 14.0 |
| B₂O₃ | 28.0 | 26.0 | 26.0 | 26.0 | 26.0 | 24.0 |
| BaO | 36.0 | 36.0 | 36.0 | 36.0 | 36.0 | 36.0 |
| ZnO | 11.0 | 11.0 | 11.0 | 11.0 | 9.0 | 11.0 |
| CaO | 12.0 | 12.0 | 6.0 | 0.0 | 12.0 | 12.0 |
| SrO | 0.0 | 0.0 | 6.0 | 12.0 | 0.0 | 0.0 |
| La₂O₃ | 3.0 | 3.0 | 3.0 | 3.0 | 5.0 | 3.0 |
| Y₂O₃ | 0.0 | 0.0 | 0.0 | 0.0 | 0.0 | 0.0 |
| Yb₂O₃ | 0.0 | 0.0 | 0.0 | 0.0 | 0.0 | 0.0 |
| CeO₂ | 0.0 | 0.0 | 0.0 | 0.0 | 0.0 | 0.0 |
| TiO₂ | 0.0 | 0.0 | 0.0 | 0.0 | 0.0 | 0.0 |
| ZrO₂ | 0.0 | 0.0 | 0.0 | 0.0 | 0.0 | 0.0 |
| Al₂O₃ | 0.0 | 0.0 | 0.0 | 0.0 | 0.0 | 0.0 |
| Total | 100.0 | 100.0 | 100.0 | 100.0 | 100.0 | 100.0 |
| Tg/° C. | 524 | 523 | 520 | 510 | 528 | 519 |
| Ts/° C. | 612 | 601 | 606 | 601 | 622 | 600 |
| Tp/° C. | 746 | 737 | 687 | 691 | 705 | 727 |
| Particle | 10.6 | 6.0 | 14.9 | 12.2 | 11.9 | 9.8 |
| size D50/μm | | | | | | |
| Thermal | 121 | 116 | 128 | 126 | 129 | 122 |
| expansion | | | | | | |
| coefficient | | | | | | |
| (α) after | | | | | | |
| treatment at | | | | | | |
| 700° C. for 1 h | | | | | | |
| 50 to 700 | | | | | | |
| Weather | 0.53 | 0.94 | — | — | — | 0.45 |
| resistance | | | | | | |

TABLE 2

| mol % | Example 7 | Example 8 | Example 9 | Example 10 | Example 11 | Example 12 |
|---|---|---|---|---|---|---|
| SiO₂ | 12.0 | 12.0 | 16.0 | 12.0 | 12.0 | 15.0 |
| B₂O₃ | 26.0 | 26.0 | 20.0 | 23.0 | 18.0 | 24.0 |
| BaO | 36.0 | 36.0 | 24.0 | 33.0 | 35.0 | 34.0 |
| ZnO | 14.0 | 17.0 | 16.0 | 15.0 | 15.0 | 25.9 |
| CaO | 9.0 | 6.0 | 19.0 | 14.0 | 14.0 | 0.0 |
| SrO | 0.0 | 0.0 | 0.0 | 0.0 | 3.0 | 0.0 |
| La₂O₃ | 3.0 | 3.0 | 0.0 | 0.0 | 0.0 | 0.1 |
| Y₂O₃ | 0.0 | 0.0 | 5.0 | 0.0 | 0.0 | 0.0 |
| Yb₂O₃ | 0.0 | 0.0 | 0.0 | 3.0 | 0.0 | 0.0 |
| CeO₂ | 0.0 | 0.0 | 0.0 | 0.0 | 3.0 | 0.0 |
| TiO₂ | 0.0 | 0.0 | 0.0 | 0.0 | 0.0 | 0.0 |
| ZrO₂ | 0.0 | 0.0 | 0.0 | 0.0 | 0.0 | 1.0 |
| Al₂O₃ | 0.0 | 0.0 | 0.0 | 0.0 | 0.0 | 0.0 |
| Total | 100.0 | 100.0 | 100.0 | 100.0 | 100.0 | 100.0 |
| Tg/° C. | 520 | 519 | 577 | 545 | 555 | 523 |
| Ts/° C. | 594 | 594 | 667 | 627 | 625 | 608 |
| Tp/° C. | 728 | 698 | 755 | 749 | 672 | 682 |
| Particle | 9.9 | 9.1 | 8.5 | 10.8 | 7.1 | 12.1 |
| size D50/μm | | | | | | |
| Thermal | 118 | 115 | 129 | 120 | 127 | 127 |
| expansion | | | | | | |
| coefficient | | | | | | |
| (α) after | | | | | | |
| treatment | | | | | | |
| at 700° C. | | | | | | |
| for 1 h | | | | | | |
| 50 to 700 | | | | | | |
| Weather | — | — | — | 0.41 | — | 0.44 |
| resistance | | | | | | |

TABLE 3

| mol % | Example 13 | Example 14 | Example 15 | Example 16 | Example 17 | Example 18 |
|---|---|---|---|---|---|---|
| SiO₂ | 20.0 | 12.0 | 10.0 | 14.8 | 14.8 | 12.8 |
| B₂O₃ | 35.0 | 26.0 | 28.0 | 23.9 | 26.9 | 25.9 |
| BaO | 35.0 | 36.0 | 36.0 | 36.2 | 33.2 | 33.2 |
| ZnO | 0.0 | 11.0 | 11.0 | 0.0 | 0.0 | 0.0 |
| CaO | 8.0 | 12.0 | 14.0 | 22.7 | 22.7 | 25.7 |
| SrO | 0.0 | 0.0 | 0.0 | 0.0 | 0.0 | 0.0 |
| La₂O₃ | 2.0 | 0.0 | 0.0 | 0.1 | 0.1 | 0.1 |
| Y₂O₃ | 0.0 | 0.0 | 0.0 | 0.0 | 0.0 | 0.0 |
| Yb₂O₃ | 0.0 | 0.0 | 0.0 | 0.0 | 0.0 | 0.0 |
| CeO₂ | 0.0 | 0.0 | 0.0 | 0.0 | 0.0 | 0.0 |
| TiO₂ | 0.0 | 3.0 | 1.0 | 1.0 | 1.0 | 1.0 |
| ZrO₂ | 0.0 | 0.0 | 0.0 | 0.0 | 0.0 | 0.0 |
| Al₂O₃ | 0.0 | 0.0 | 0.0 | 1.3 | 1.3 | 1.3 |
| Total | 100.0 | 100.0 | 100.0 | 100.0 | 100.0 | 100.0 |
| Tg/° C. | 591 | 520 | 511 | 536 | 547 | 537 |
| Ts/° C. | 651 | 594 | 584 | 617 | 618 | 608 |
| Tp/° C. | 741 | 686 | 664 | 712 | 723 | 701 |
| Particle | 13.9 | 7.8 | 12.0 | 12.2 | 9.3 | 11.9 |
| size D50/μm | | | | | | |
| Thermal | 125 | 111 | 110 | 137 | 143 | 142 |
| expansion | | | | | | |
| coefficient | | | | | | |
| (α) after | | | | | | |
| treatment | | | | | | |
| at 700° C. | | | | | | |
| for 1 h | | | | | | |
| 50 to 700 | | | | | | |
| Weather | — | — | 0.72 | — | — | — |
| resistance | | | | | | |

TABLE 4

| mol % | Example 19 | Example 20 | Example 21 | Example 22 | Example 23 | Example 24 |
|---|---|---|---|---|---|---|
| SiO₂ | 14.8 | 14.8 | 12.8 | 16.8 | 12.8 | 16.8 |
| B₂O₃ | 23.9 | 23.9 | 25.9 | 21.9 | 25.9 | 21.9 |
| BaO | 36.2 | 36.2 | 33.2 | 39.2 | 23.2 | 33.2 |
| ZnO | 22.7 | 11.4 | 0.0 | 0.0 | 0.0 | 12.9 |
| CaO | 0.0 | 11.4 | 25.7 | 19.7 | 25.7 | 12.8 |
| SrO | 0.0 | 0.0 | 0.0 | 0.0 | 10.0 | 0.0 |
| La₂O₃ | 0.1 | 0.1 | 0.1 | 0.1 | 0.1 | 0.1 |
| Y₂O₃ | 0.0 | 0.0 | 0.0 | 0.0 | 0.0 | 0.0 |
| Yb₂O₃ | 0.0 | 0.0 | 0.0 | 0.0 | 0.0 | 0.0 |
| CeO₂ | 0.0 | 0.0 | 0.0 | 0.0 | 0.0 | 0.0 |
| TiO₂ | 1.0 | 1.0 | 1.0 | 1.0 | 1.0 | 1.0 |
| ZrO₂ | 0.0 | 0.0 | 0.0 | 0.0 | 0.0 | 0.0 |
| Al₂O₃ | 1.3 | 1.3 | 1.3 | 1.3 | 1.3 | 1.3 |
| Total | 100.0 | 100.0 | 100.0 | 100.0 | 100.0 | 100.0 |
| Tg/° C. | 520 | 524 | 546 | 526 | 548 | 533 |
| Ts/° C. | 605 | 597 | 619 | 596 | 618 | 610 |
| Tp/° C. | 663 | 714 | 778 | 699 | 684 | 714 |
| Particle | 13.2 | 9.2 | 11.4 | 11.7 | 11.7 | 9.6 |
| size D50/μm | | | | | | |
| Thermal | 143 | 145 | 133 | 131 | 149 | 125 |
| expansion | | | | | | |
| coefficient | | | | | | |
| (α) after | | | | | | |
| treatment | | | | | | |
| at 700° C. | | | | | | |
| for 1 h | | | | | | |
| 50 to 700 | | | | | | |
| Weather | — | — | — | — | 0.53 | 0.40 |
| resistance | | | | | | |

TABLE 5

| mol % | Example 25 | Example 26 | Example 27 | Example 28 | Example 29 | Example 30 |
|---|---|---|---|---|---|---|
| SiO₂ | 12.8 | 18.8 | 18.8 | 14.8 | 12.8 | 13.0 |
| B₂O₃ | 25.9 | 19.9 | 19.9 | 23.9 | 25.9 | 26.0 |
| BaO | 24.2 | 33.2 | 33.2 | 33.2 | 39.2 | 36.0 |
| ZnO | 0.0 | 0.0 | 12.9 | 25.7 | 9.7 | 11.0 |
| CaO | 34.7 | 25.7 | 12.8 | 0.0 | 10.0 | 13.0 |
| SrO | 0.0 | 0.0 | 0.0 | 0.0 | 0.0 | 0.0 |
| La₂O₃ | 0.1 | 0.1 | 0.1 | 0.1 | 0.1 | 0.0 |
| Y₂O₃ | 0.0 | 0.0 | 0.0 | 0.0 | 0.0 | 0.0 |
| Yb₂O₃ | 0.0 | 0.0 | 0.0 | 0.0 | 0.0 | 0.0 |
| CeO₂ | 0.0 | 0.0 | 0.0 | 0.0 | 0.0 | 0.0 |
| TiO₂ | 1.0 | 1.0 | 1.0 | 1.0 | 1.0 | 1.0 |
| ZrO₂ | 0.0 | 0.0 | 0.0 | 0.0 | 0.0 | 0.0 |
| Al₂O₃ | 1.3 | 1.3 | 1.3 | 1.3 | 1.3 | 0.0 |
| Total | 100.0 | 100.0 | 100.0 | 100.0 | 100.0 | 100.0 |
| Tg/° C. | 553 | 553 | 533 | 525 | 517 | 518 |
| Ts/° C. | 621 | 628 | 613 | 605 | 590 | 604 |
| Tp/° C. | 696 | 750 | 689 | 663 | 690 | 733 |
| Particle | 11.4 | 8.5 | 8.3 | 7.8 | 11.4 | 14.6 |
| size D50/μm | | | | | | |
| Thermal | 149 | 133 | 138 | 150 | 125 | 118 |
| expansion | | | | | | |
| coefficient | | | | | | |
| (α) after | | | | | | |
| treatment | | | | | | |
| at 700° C. | | | | | | |
| for 1 h | | | | | | |
| 50 to 700 | | | | | | |
| Weather | — | — | — | — | — | — |
| resistance | | | | | | |

TABLE 6

| mol % | Example 31 | Example 32 | Example 33 | Example 34 | Example 35 | Example 36 |
|---|---|---|---|---|---|---|
| SiO₂ | 18.5 | 16.0 | 18.0 | 10.5 | 16.0 | 10.0 |
| B₂O₃ | 22.0 | 25.0 | 28.0 | 25.0 | 25.0 | 26.0 |
| BaO | 33.0 | 43.0 | 33.0 | 32.0 | 43.0 | 36.0 |
| ZnO | 0.0 | 0.0 | 11.0 | 5.0 | 0.0 | 11.0 |
| CaO | 21.0 | 10.0 | 0.0 | 15.0 | 7.0 | 12.0 |
| SrO | 0.0 | 0.0 | 8.0 | 0.0 | 0.0 | 0.0 |
| La₂O₃ | 0.0 | 3.0 | 0.0 | 5.0 | 3.0 | 3.0 |
| Y₂O₃ | 0.0 | 0.0 | 0.0 | 0.0 | 0.0 | 0.0 |
| Yb₂O₃ | 0.0 | 0.0 | 0.0 | 0.0 | 0.0 | 0.0 |
| CeO₂ | 0.0 | 0.0 | 0.0 | 0.0 | 0.0 | 0.0 |
| TiO₂ | 1.0 | 2.0 | 0.0 | 3.0 | 5.0 | 0.0 |
| ZrO₂ | 0.0 | 0.0 | 0.0 | 0.0 | 0.0 | 0.0 |
| Al₂O₃ | 4.5 | 1.0 | 2.0 | 4.5 | 1.0 | 2.0 |
| Total | 100.0 | 100.0 | 100.0 | 100.0 | 100.0 | 100.0 |
| Tg/° C. | 556 | 539 | 550 | 562 | 540 | 529 |
| Ts/° C. | 644 | 624 | 627 | 644 | 610 | 611 |
| Tp/° C. | 788 | 714 | 703 | 764 | 829 | 748 |
| Particle | 12.8 | 12.8 | 14.0 | 7.6 | 9.4 | 12.2 |
| size D50/μm | | | | | | |
| Thermal | 127 | 149 | 132 | 150 | 149 | 141 |
| expansion | | | | | | |
| coefficient | | | | | | |
| (α) after | | | | | | |
| treatment | | | | | | |
| at 700° C. | | | | | | |
| for 1 h | | | | | | |
| 50 to 700 | | | | | | |
| Weather | — | — | — | — | — | — |
| resistance | | | | | | |

TABLE 7

| | Comparative | Comparative | Comparative | Comparative | Comparative |
|---|---|---|---|---|---|
| mol % | Example 1 | Example 2 | Example 3 | Example 4 | Example 5 |
| SiO₂ | 15.0 | 13.7 | 16.8 | 14.8 | 8.0 |
| B₂O₃ | 20.0 | 17.3 | 21.9 | 20.9 | 26.0 |
| BaO | 8.0 | 11.2 | 30.2 | 20.1 | 36.0 |
| Zno | 12.0 | 0.0 | 28.7 | 0.0 | 10.0 |
| CaO | 0.0 | 30.6 | 0.0 | 22.7 | 12.0 |
| La₂O₃ | 5.0 | 0.0 | 0.1 | 0.1 | 3.0 |
| TiO₂ | 0.0 | 0.0 | 1.0 | 1.0 | 0.0 |
| Al₂O₃ | 5.0 | 0.0 | 1.3 | 1.3 | 5.0 |
| MgO | 35.0 | 27.2 | 0.0 | 19.1 | 0.0 |
| Total | 100.0 | 100.0 | 100.0 | 100.0 | 100.0 |
| Tg/° C. | 660 | 610 | 535 | 565 | 532 |
| Ts/° C. | 749 | 683 | 621 | 658 | 613 |
| Tp/° C. | 894 | 758 | Not detected | Not detected | 750 |
| Particle | 5.6 | 13.0 | 12.8 | 11.5 | 7.4 |
| size D50/μm | | | | | |
| Thermal | No | No | Glass was | Glass was | Glass was |
| expansion | flowability | flowability | not | not | not |
| coefficient | at 700° C. | at 700° C. | crystallized | crystallized | crystallized |
| (α) after | | | and was | and was | and was |
| treatment | | | softened | softened | softened |
| at 700° C. | | | | | |
| for 1 h | | | | | |
| 50 to 700 | | | | | |

TABLE 8

| | Example 37 | Example 38 |
|---|---|---|
| Glass:Filler (wt %) | 90:10 | 90:10 |
| Glass | Example 2 | Example 7 |
| Filler | Barium titanate | Steatite |
| Thermal expansion coefficient (α) | 124 | 120 |
| after treatment at 700° C. for 1 h | | |
| 50 to 700 | | |

As seen from the results of DTA measurement at a temperature rising rate of 20° C./min from room temperature in each table, each of the glass compositions of Examples of the present invention has a softening point that exhibits sufficient flowability at a firing temperature at the time of sealing in a range of 650 to 750° C., and also has a crystallization peak temperature at which each of the glass compositions forms a crystallized glass as intended by firing within this temperature range in a sealing step in which the temperature rising rate is much slower. Actually, it was confirmed that the glass composition of each Example formed a crystallized glass by the firing. In addition, the thermal expansion coefficient at 50 to 700° C. of the crystallized glass after firing is also 110 to 150×10⁻⁷/° C., indicating glass temperature characteristics suitable for the purpose of the present invention. On the other hand, the glass compositions of Comparative Examples did not fluidize or crystallize at the firing temperature. Further, it was confirmed that the thermal expansion coefficients of the glass compositions of Examples 37 and 38 in which the filler was blended could be finely adjusted by blending the filler.

### 3. Examples 39 to 47

Glass flakes, glass powders, and glass plates were prepared and subjected to each test in the same procedure as in Examples 1 to 38 except that raw materials were prepared and mixed so as to give the glass compositions of Examples 39 to 47 containing WO₃ and/or Nb₂O₅ as shown in Tables 9 and 10. The results are shown in Tables 9 and 10.

TABLE 9

| mol % | Example 39 | Example 40 | Example 41 | Example 42 | Example 43 |
|---|---|---|---|---|---|
| SiO₂ | 12.0 | 12.0 | 10.0 | 12.0 | 14.0 |
| B₂O₃ | 25.0 | 28.0 | 25.0 | 20.0 | 22.0 |
| BaO | 35.0 | 35.0 | 38.0 | 35.0 | 32.0 |
| ZnO | 11.0 | 10.0 | 8.0 | 15.0 | 12.0 |
| CaO | 12.0 | 10.0 | 15.0 | 12.0 | 14.0 |
| SrO | 0.0 | 0.0 | 0.0 | 0.0 | 0.0 |
| La₂O₃ | 3.0 | 3.0 | 2.0 | 4.0 | 5.0 |
| Y₂O₃ | 0.0 | 0. | 0.0 | 0.0 | 0.0 |
| Yb₂O₃ | 0.0 | 0.0 | 0.0 | .0 | 0.0 |
| CeO₂ | 0.0 | 0.0 | 0.0 | 0.0 | 0.0 |
| TiO₂ | 0.0 | 0.0 | 0.0 | 0.0 | 0.0 |
| ZrO₂ | 0.0 | 0.0 | 0.0 | 0.0 | 0.0 |
| Al₂O₃ | 0.0 | 0.0 | 0.0 | 0.0 | 0.0 |
| WO₃ | 2.0 | 2.0 | 2.0 | 2.0 | 1.0 |
| Nb₂O₅ | 0.0 | 0.0 | 0.0 | 0.0 | 0.0 |
| Total | 100.0 | 100.0 | 100.0 | 100.0 | 100.0 |
| Tg/° C. | 523 | 534 | 519 | 555 | 550 |
| Ts/° C. | 603 | 599 | 589 | 620 | 662 |
| Tp/° C. | 741 | 685 | 723 | 676 | 700 |
| Particle size | 10.8 | 12.5 | 7.0 | 5.9 | 7.3 |
| D50/μm | | | | | |
| Thermal | 117 | 124 | 121 | 126 | 130 |
| expansion | | | | | |
| coefficient (α) | | | | | |
| after treatment | | | | | |
| at 700° C. for 1 h | | | | | |
| 50 to 700 | | | | | |
| Weather | 0.28 | 0.21 | 0.31 | 0.08 | 0.15 |
| resistance | | | | | |

TABLE 10

| mol % | Example 44 | Example 45 | Example 46 | Example 47 |
|---|---|---|---|---|
| SiO₂ | 18.0 | 12.0 | 10.0 | 10.0 |
| B₂O₃ | 23.0 | 20.0 | 23.0 | 23.0 |
| BaO | 32.0 | 35.0 | 40.0 | 38.0 |
| ZnO | 14.0 | 15.0 | 8.0 | 8.0 |
| Cao | 10.0 | 12.0 | 15.0 | 15.0 |
| Sro | 0.0 | 0.0 | 0.0 | 0.0 |
| La₂O₃ | 1.0 | 4.0 | 2.0 | 2.0 |
| Y₂O₃ | 0.0 | 0.0 | 0.0 | 0.0 |
| Yb₂O₃ | 0.0 | 0.0 | 0.0 | 0.0 |
| CeO₂ | 0.0 | 0.0 | 0.0 | 0.0 |
| TiO₂ | 0.0 | 0.0 | 0.0 | 0.0 |
| ZrO₂ | 0.0 | 0.0 | 0.0 | 0.0 |
| Al₂O₃ | 0.0 | 0.0 | 0.0 | 0.0 |
| WO₃ | 2.0 | 0.0 | 0.0 | 2.0 |
| Nb₂O₅ | 0.0 | 2.0 | 2.0 | 2.0 |
| Total | 100.0 | 100.0 | 100.0 | 100.0 |
| Tg/° C. | 541 | 564 | 531 | 535 |
| Ts/° C. | 615 | 642 | 610 | 612 |
| Tp/° C. | 710 | 699 | 694 | 714 |
| Particle size | 10.8 | 6.5 | 5.3 | 5.0 |
| D50/μm | | | | |
| Thermal | 139 | 136 | 130 | 133 |
| expansion | | | | |
| coefficient (α) | | | | |
| after treatment | | | | |
| at 700° C. for | | | | |
| 1 h 50 to 700 | | | | |
| Weather | 0.11 | 0.01 | 0.32 | 0.26 |
| resistance | | | | |

As can be seen from Tables 9 and 10, each of the glass compositions of Examples 39 to 47 has a softening point and a crystallization peak temperature suitable for the purpose of the present invention, similarly to Examples 1 to 36, and forms a crystallized glass by firing, and the thermal expansion coefficient of the crystallized glass at 50 to 700° C. after firing is also in a range of 110 to 150×10⁻⁷/° C. Furthermore, the glass compositions of Examples 39 to 47 have significantly better weather resistance than the glass compositions of Examples 1 to 36.

### INDUSTRIAL APPLICABILITY

The glass composition of the present invention can be used as a sealing material in an environment exposed to 650° C. to 750° C. such as a solid oxide fuel cell (SOFC) for sealing a metal member and a ceramic member or metal members by bringing into contact with the metal and the ceramic and firing at 650 to 750° C., or a temperature sensor.

1. A sealing glass composition substantially not comprising alkali metal oxides, and comprising, in mol %,
8 to 20% of SiO₂,
16 to 35% of B₂O₃,
23 to 43% of BaO,
0 to 26% of ZnO, and
0 to 36% of CaO+SrO,
wherein the glass composition, when fired at a temperature of 700° C. in a form of a powder, forms a crystallized glass that exhibits a thermal expansion coefficient of 110 to 150× 10⁻⁷/° C. at 50 to 700° C.

2. The sealing glass composition according to claim 1, substantially not comprising alkali metal oxides, and comprising, in mol %,
10 to 20% of SiO₂,
20 to 28% of B₂O₃,
30 to 40% of BaO,
8 to 15% of ZnO, and
5 to 15% of CaO+SrO,
wherein the glass composition, when fired at a temperature of 700° C. in a form of a powder, forms a crystallized glass that exhibits a thermal expansion coefficient of 110 to 150×10⁻⁷/° C. at 50 to 700° C.

3. The sealing glass composition according to claim 1, comprising one or more selected from the group consisting of La₂O₃, Y₂O₃, Yb₂O₃ and CeO₂ at 5 mol % or less in total.

4. The sealing glass composition according to claim 1, comprising one or two selected from the group consisting of TiO₂ and ZrO₂ at 5 mol % or less in total.

5. The sealing glass composition according to claim 1, comprising one or two selected from the group consisting of WO₃ and Nb₂O₅ at 4 mol % or less in total.

6. The sealing glass composition according to claim 1, which is in a form of a powder.

7. The sealing glass composition according to claim 6, wherein the powder has a mean particle size of 5 to 15 μm.

8. The sealing glass composition according to claim 6, comprising a ceramic filler.

9. A sealing glass composition comprising a pressed powder compact obtained by pressing the powder according to claim 6.

10. The sealing glass composition according to claim 6, which comprises a solvent and an organic binder and is in a paste-like or sheet-like form.
